(19) United States
(12) Patent Application Publication
(10) Pub. No.: US 2012/0059606 A1
(43) Pub. Date: Mar. 8, 2012

(54) ELECTRONIC DEVICE, ELECTRONIC DEVICE MANAGEMENT SYSTEM, CONTROL METHOD OF ELECTRONIC DEVICE, CONTROL METHOD OF ELECTRONIC DEVICE MANAGEMENT SYSTEM, AND STORAGE MEDIUM

(75) Inventor: Daiki Ikari, Ayase-shi (JP)

(73) Assignee: CANON KABUSHIKI KAISHA, Tokyo (JP)

(21) Appl. No.: 13/218,252

(22) Filed: Aug. 25, 2011

(30) Foreign Application Priority Data
Sep. 8, 2010 (JP) 2010-200573

(51) Int. Cl. G06F 19/00

(52) U.S. Cl. 702/61

(57) ABSTRACT

An electronic device to operate in one of a first power mode and a second power mode during which power consumption is lower than during the first power mode. The electronic device includes an electronic device, a first calculation unit, and a second calculation unit. The measurement unit measures power consumption of the electronic device in the first power mode. The first calculation unit calculates power consumption of the electronic device in the second power mode. The second calculation unit calculates total power consumption of the electronic device by adding power consumption measured by the measurement unit and power consumption calculated by the first calculation unit.

### BACKGROUND OF THE INVENTION

1. Field of the Invention

The present invention relates to an electronic device, an electronic device management system, a control method of an electronic device, a control method of an electronic device management system, and a storage medium.

2. Description of the Related Art

Recently, a reduction in power consumption when using an electronic device (hereinafter referred to as a device), such as a printer or a multifunction peripheral, has been desired to decrease emissions of greenhouse gas including carbon dioxide. It is thus desirable for power consumption of a device to be recognizable (i.e., be viewable) by a user when using the device.

For example, Japanese Patent Application Laid-Open No. 2003-335026 discusses a system including a plurality of copying machines (i.e., image forming apparatuses) capable of measuring power consumption, and a management apparatus thereof, connected to a network. In such a system, each of a plurality of the copying machines transmits data on the measured power consumption according to a request from the management apparatus. According to Japanese Patent Application Laid-Open No. 2003-335026, the management apparatus can collectively manage a history of monthly power consumption for each copying machine.

Further, Japanese Patent Application Laid-Open No. 2010-072870 discusses a system in which a plurality of devices and a power consumption calculation apparatus are connected to a network. In such a system, the power consumption calculation apparatus acquires a job work amount and an operation status of each device, and then calculates (estimates) the power consumption of each device.

However, since the copying machine in the system discussed in Japanese Patent Application Laid-Open No. 2010-335026 constantly measures power consumption, power becomes consistently consumed in measuring the power consumption. Such power consumption accounts for a small percentage of the power consumption of the copying machine when the copying machine is in a dynamic state such as executing a job. However, such power consumption accounts for a large percentage when the copying machine is maintained in a static state for a long time, such as in a sleep mode (i.e., a power saving state). Then, such power consumption is not negligible.

Further, according to Japanese Patent Application Laid-Open No. 2010-072870, the calculation apparatus constantly calculates (estimates) the power consumption of each device instead of measuring the power consumption. In such a case, it becomes difficult to accurately estimate the power consumption of the device in the dynamic state such as when the device is performing a job.

### SUMMARY OF THE INVENTION

The present invention is directed to providing a technique for appropriately measuring the power consumption while reducing the percentage of the power consumed in measuring the power consumption.

According to an aspect of the present invention, an electronic device operates in one of a first power mode and a second power mode during which power consumption is lower than during the first power mode, and includes: a measurement unit configured to measure power consumption of the electronic device in the first power mode; a first calculation unit configured to calculate power consumption of the electronic device in the second power mode; and a second calculation unit configured to calculate total power consumption of the electronic device by adding power consumption measured by the measurement unit and power consumption calculated by the first calculation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a configuration of an image forming apparatus that is an exemplary embodiment of an electronic device according to an exemplary embodiment.

FIG. 2 is a block diagram illustrating a power supply configuration and a configuration example of a power measurement unit 30 in an image forming apparatus 100.

FIG. 3 is a plane view illustrating a configuration example of an operation unit 60.

FIG. 4 is a block diagram illustrating an example of a software configuration of a power consumption management program 1290 executed by the image forming apparatus 100 according to a first exemplary embodiment.

FIG. 5 is a flowchart illustrating a process performed in the image forming apparatus for measuring and calculating power consumption, and shifting to and recovering from a sleep mode according to the first exemplary embodiment.

FIG. 6 is a flowchart illustrating an example of a process for updating power consumption information based on measurement.

FIG. 7 is a flowchart illustrating an example of a process for updating power consumption information based on estimation operation.

FIG. 8 illustrates an example of a display screen displaying power consumption information of the image forming apparatus 100 according to the first exemplary embodiment.

FIG. 9 illustrates a system configuration which is an example of a network system that mainly manages power consumption information of one or a plurality of image forming apparatuses by applying an electronic device management system according to a second exemplary embodiment.

FIG. 10 is a block diagram illustrating an example of a hardware configuration of a power consumption calculation management server 200.

FIG. 11 is a block diagram illustrating an example of a power consumption calculation management program 1340 executed by the power consumption calculation management server 200.

FIG. 12 illustrates an example of a sleep mode power consumption table 1345.

FIG. 13 is a block diagram illustrating an example of a software configuration of a power consumption management program 1400 executed by each image forming apparatus according to the second exemplary embodiment.

FIG. 14 (14A and 14B) is a flowchart illustrating processes performed by image forming apparatuses 100, 101, and 102 and the power consumption calculation management server 200 according to the second exemplary embodiment.

### DESCRIPTION OF THE EMBODIMENTS

Various exemplary embodiments, features, and aspects of the invention will be described in detail below with reference to the drawings.

An image forming apparatus will be described below as an example of an electronic device (i.e., device) according to an exemplary embodiment. The examples are applicable to an electronic device other than the image forming apparatus as long as the device includes a function for switching between a normal mode and a power saving mode (hereinafter referred to as a sleep mode) to realize power saving.

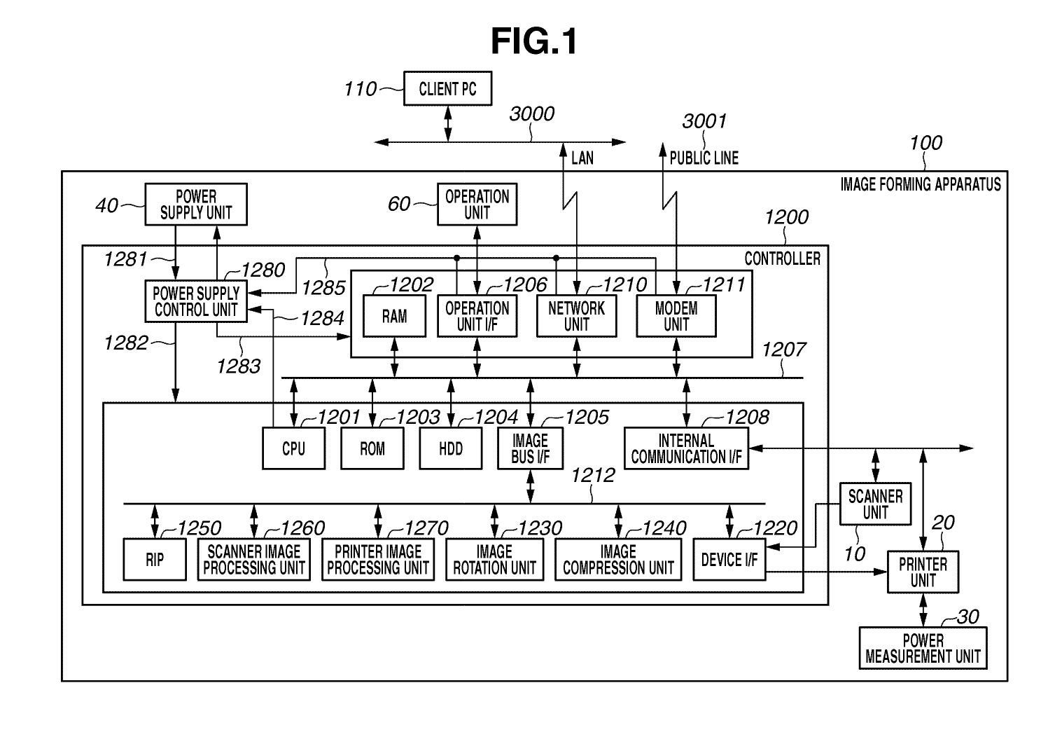

FIG. 1 is a block diagram illustrating an example of a configuration of an image forming apparatus as an example of the electronic device according to an exemplary embodiment.

Referring to FIG. 1, an image forming apparatus 100, i.e., an electronic device, includes a power saving function for switching an operation mode between the normal mode and the power saving mode (i.e., a sleep mode). The image forming apparatus 100 is capable of calculating or measuring the power consumption thereof using the configuration to be described below.

The image forming apparatus 100 includes an operation unit 60, a scanner unit 10, a printer unit 20, a power supply unit 40, a power measurement unit 30, and a controller 1200. The operation unit 60 is used by the user of the image forming apparatus 100 to perform various operations. The scanner unit 10 reads image information, and the printer unit 20 prints image data on a sheet according to a user instruction from the operation unit 60. The power supply unit 40 supplies power to each unit in the image forming apparatus 100, and the power measurement unit 30 measures the power consumption of the image forming apparatus 100. The controller 1200 is connected to the scanner unit 10, the printer unit 20, a local area network (LAN) 3000, and a public line (i.e., a wide area network (WAN) 3001), and collectively controls the operation of the image forming apparatus. The controller 1200 also performs input/output control of image information, device information, and power consumption information.

The controller 1200 and units included therein will be described in detail below with reference to FIG. 1. Referring to FIG. 1, the controller 1200 receives a print job from a client personal computer (PC) 110 on the LAN 3000 via the LAN 3000. A raster image processor (RIP) 1250 then rasterizes a print description language (PDL) code included in the received print job into a bit map image. The controller 1200 includes a scanner image processing unit 1260 that corrects, processes, and edits the image data input from the scanner unit 10.

The controller 1200 includes a printer image processing unit 1270 that corrects and performs resolution conversion on the image data to be output from (i.e., printed by) the printer unit 20, and an image rotation unit 1230 rotates such image data. The controller 1200 further includes an image compression unit 1240 that performs joint photographic experts group (JPEG) compression and decompression on multivalued image data. Further, the image compression unit 1240 performs joint bi-level image experts group (JBIG), modified relative element address designate (MMR), or modified Huffman (MH) compression and decompression on binary image data.

The controller 1200 includes a device interface (I/F) 1220 that connects the scanner unit 10 and the printer unit 20 to the controller 1200 and performs synchronous and asynchronous conversion of the image data. The controller 1200 further includes an image bus 1212 that connects the RIP 1250, the scanner image processing unit 1260, the printer image processing unit 1270, the image rotation unit 1230, the image compression unit 1240, and the device I/F 1220 with each other, and transfers the image data at high speed between the units.

The controller 1200 further includes a central processing unit (CPU) 1201, i.e., a control unit, that collectively controls the image forming apparatus 100, and a random access memory (RAM) 1202 that functions as a system work memory for the CPU 1201 to operate and as an image memory for the CPU 1201 to temporarily store the image data.

The controller 1200 further includes an operation unit I/F 1206, i.e., an interface to the operation unit 60, that outputs to the operation unit 60 the image data to be displayed on the operation unit 60. The operation unit I/F 1206 also notifies the CPU 1201 of the information that a user of the image forming apparatus 100 has input to the operation unit 60.

The controller 1200 includes a network unit 1210 that is connected to the LAN 3000 and communicates (i.e., performs transmission and reception) with the client PC 110 and other computer terminals (not illustrated) on the LAN 3000. The controller 1200 further includes a modem unit 1211 that is connected to the public line 3001 and performs data communication with (i.e., transmits and receives data to and from) an external facsimile apparatus (not illustrated).

The controller 1200 further includes a read-only memory (ROM) 1203 that stores a boot program to be executed by the CPU 1201, a hard disk drive (HDD) 1204 that stores system software, the image data, and software counter values, and an internal communication I/F 1208 that communicates with each of the CPU in the scanner unit 10 and the printer unit 20.

The controller 1200 further includes a system bus 1207 that connects the CPU 1201, the RAM 1202, the operation unit I/F 1206, the network unit 1210, the modem unit 1211, the ROM 1203, the HDD 1204, and the internal communication I/F 1208 with each other.

The controller 1200 further includes an image bus I/F 1205, which is a bus bridge that connects the system bus 1207 and an image bus 1212, and converts data structure.

The controller 1200 further includes a power supply control unit 1280 that supplies a direct current (DC) power supply received from the power supply unit 40 via a power supply line 1281 to a predetermined circuit element in the controller 1200 via power supply lines 1282 and 1283.

The power supply control unit 1280 is controlled based on a control signal received from the operation unit I/F 1206, the network unit 1210, and the modem unit 1211 via a control signal line 1285, and a control signal received from the CPU 1201 via a control signal line 1284.

Further, the power supply control unit 1280 may control the power supply unit 40 according to an instruction from the CPU 1201. Furthermore, the power supply control unit 1280 selectively switches on and off the power supply lines 1282 and 1283.

The power supply line 1282 is connected to the CPU 1201, the ROM 1203, the HDD 1204, the image bus I/F 1205, and the internal communication I/F 1208. Further, the power supply line 1282 is connected to the device I/F 1220, the image rotation unit 1230, the image compression unit 1240, the RIP 1250, the scanner image processing unit 1260, and the printer image processing unit 1270. On the other hand, the power supply line 1283 is connected to the RAM 1202, the operation unit I/F 1206, the network unit 1210, and the modem unit 1211.

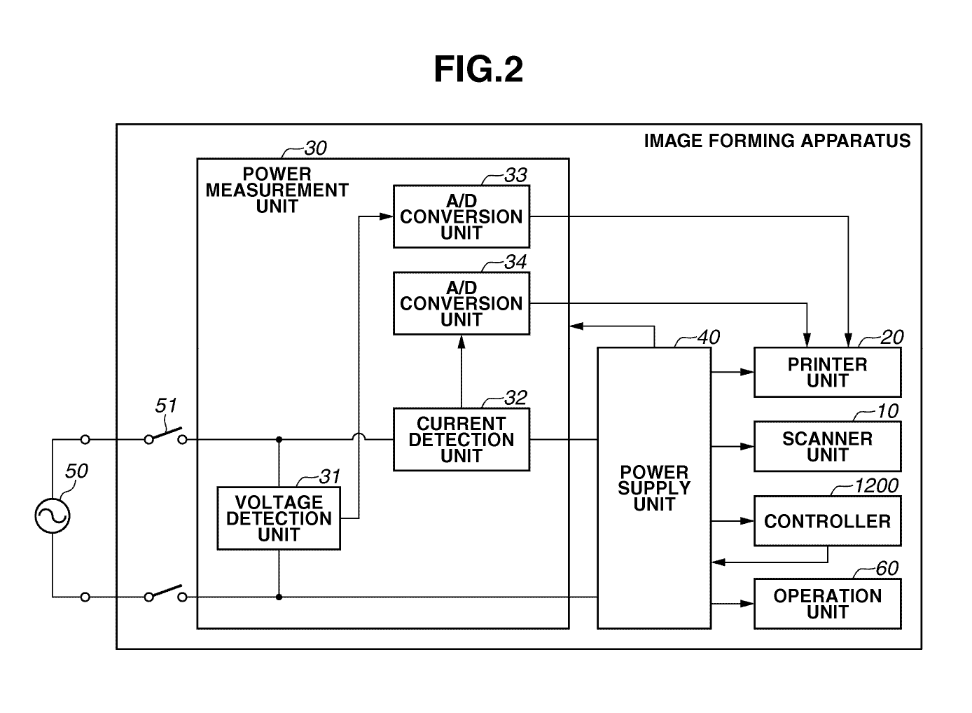

FIG. 2 illustrates examples of a power supply configuration inside the image forming apparatus 100 and a configuration of the power measurement unit 30.

Referring to FIG. 2, a commercial power supply 50 is connected to the power supply unit 40 via a main power supply switch 51 and the power measurement unit 30. The power supply unit 40 internally generates using the commercial power supply 50 and supplies the power necessary for each unit in the image forming apparatus 100, such as the printer unit 20, the scanner unit 10, the power measurement unit 30, the controller 1200, and the operation unit 60.

Further, the power supply unit 40 is capable of switching on and off the power to be supplied to the printer unit 20, the scanner unit 10, and the operation unit 60, according to an instruction from the controller 1200.

The power measurement unit 30 will be described in detail below with reference to FIG. 2. The power measurement unit 30 includes a voltage detection unit 31 and a current detection unit 32. The voltage detection unit 31 reads a voltage value, and the current detection unit 32 reads a current value.

More specifically, the voltage may be detected by performing full-wave rectification of the voltages input from a line (L) and a neutral line (N) of a general commercial power supply. The voltage between the L and N lines is then reduced using a transformer, and the value is read by an analog/digital (A/D) conversion unit 33. Further, the current may be detected by converting the value of the current flowing in the L line to a magnetic flux, converting the magnetic flux to the voltage, and reading the value using an A/D conversion unit 34. The current may also be read by inserting a current value detection resistor. Furthermore, the current may be read by inserting an element whose temperature changes when the current flows in the element.

According to the present exemplary embodiment, the voltage level and the current level detected by the above-described methods and performed A/D conversion respectively by the A/D conversion unit 33 and 34 are input to the printer unit 20. The CPU (not illustrated) in the printer unit 20 then reads the voltage level and the current level, and a storage unit (not illustrated) in the printer unit 20 stores a product of the two values as the power consumption.

Further, the CPU in the printer unit 20 reads the voltage level and the current level, and calculates and stores the power consumption at constant time intervals. The CPU then multiplies the length of the time interval to the power consumption (i.e., power consumption×time interval), and thus calculates the power consumption in the constant time period.

The printer unit 20 communicates with the internal communication I/F 1208 in the controller 1200, so that the printer unit 20 can transmit to the CPU 1201 in the controller 1200 the power consumption calculated therein based on the measurement result.

The power consumption may also be calculated in the controller 1200 or the scanner unit 10 instead of the printer 20.

Further, the power consumption may be calculated in the power measurement unit 30 by embedding in the power measurement unit 30 a digital signal processor (DSP) that calculates digital data at high speed. In such a case, the power measurement unit 30 may be directly connected to the controller 1200 via the internal communication I/F 1208.

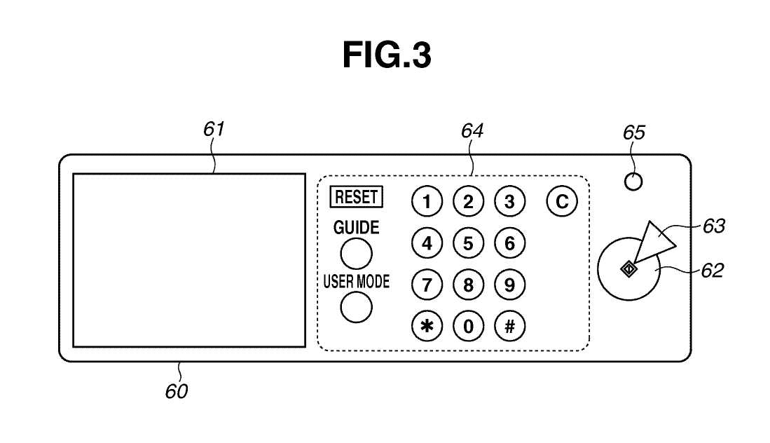

FIG. 3 is a plane view illustrating a configuration example of the operation unit 60. Referring to FIG. 3, a liquid crystal operation panel 61 is a combination of a liquid crystal and a touch panel. The liquid crystal operation panel 61 displays an operation screen and transmits, when the user presses a displayed key, the information to the controller 1200.

A start key 62 is used by the user for instructing the image forming apparatus 100 to start reading and printing a document image, and other functions. Green and red light emitting diodes (LED) are embedded in the start key 62. When the green color is lit up, it indicates that an operation can be started, and when the red color is lit up, it indicates the operation cannot be started. A stop key 63 is used to stop the function in operation. A hard key group 64 includes a numerical keypad, a clear key, a reset key, a guide key, and a user mode key.

A power save key 65 is used when the user instructs the image forming apparatus 100 via operation unit 60 to shift to a sleep mode, or to recover from the sleep mode to the normal mode. The image forming apparatus shifts to the sleep mode when the user presses the power save key 65 in the normal mode, and to the normal mode when the user presses the power save key 65 in the sleep mode.

The image forming apparatus 100 illustrated in FIG. 1 performs the printing process as described below based on the print job transmitted from the client computer (client PC) 110 connected to the LAN 3000.

The CPU 1201 stores in the RAM 1202 the print data, i.e., the image data, received via the network unit 1210 from the client PC 110 connected to the LAN 3000. The CPU 1201 then supplies the image data to the RIP 1250 via the image bus I/F 1205.

The RIP 1250 then rasterizes the image data (i.e., the PDL code) supplied from the CPU 1201 to the bitmap data. The image compression unit 1240 compresses the rasterized bitmap data and stores the data in the HDD 1204.

The image data (i.e., compressed bitmap data) stored in the HDD 1204 is then supplied to the image compression unit 1240 via the image bus I/F 1205. The image compression unit 1240 decompresses the supplied image data (i.e., compressed bitmap data).

The printer image processing unit 1270 then performs correction and resolution conversion on the decompressed bitmap data for printing by the printer unit 20. The image rotation unit 1230 rotates the bitmap data as necessary. The processed bitmap data is then transmitted to the printer unit 20 via the device I/F 1220 as the print data, and the printer unit 20 prints the print data on a printing medium such as a paper sheet.

Further, the printer unit 20 acquires the measurement value of the power measurement unit 30 at constant time intervals and calculates the power consumption while executing the above-described print job. The printer unit 20 can thus transmit to the controller 1200 the amount of the power consumption according to the request from the controller 1200.

The calculation interval of the power consumption of the printer unit 20, i.e., an interval for reading an output value of the power measurement unit 30 by the printer 20, may be freely set within a range of not affecting the print job and other print processing. Further, the interval for the controller 1200 to request the printer unit 20 for the consumed power amount may also be freely set within a range of not affecting the other processes performed in the controller 1200.

The image forming apparatus 100 can operate in the sleep mode which is one of the power saving modes. Referring to FIG. 2, when the image forming apparatus 100 is in the normal mode, the power supply unit 40 supplies the power to the scanner unit 10, the printer unit 20, the power measurement unit 30, the operation unit 60, and the controller 1200. Further, the power supply unit 40 supplies power to the power supply control unit 1280 via the power supply line 1281 in the controller 1200, as illustrated in FIG. 1.

Furthermore, the CPU 1201 controls the power supply control unit 1280 to switch on each of the power supply lines 1282 and 1283. As a result, the power supply unit 40 supplies power to all units in the controller 1200 including both the CPU 1201 and the network unit 1210.

On the other hand, when the image forming apparatus 100 is in the sleep mode, the power supply unit 40 receives an instruction from the controller unit 1200, and does not supply power to the scanner unit 10, the printer unit 20, the power measurement unit 30, and the operation unit 60. The power supply unit 40 supplies power to only the controller 1200 via the power supply line 1281.

The power is thus supplied to the power supply control unit 1280 in the controller 1200, and the CPU 1201 controls the power supply control unit 1280 to switch off the power supply line 1282 and switched on the power supply line 1283. As a result, the power supply to the main circuit elements including the CPU 1201 in the controller 1200 is cut off, so that the power consumption in the image forming apparatus 100 can be greatly reduced.

Further, when the network unit 1210 receives the data of the print job from the client PC 110 on the LAN 3000, the network unit 1210 can control the power supply control unit 1280 so that the image forming apparatus 100 recovers to the normal mode.

According to the present exemplary embodiment, the power supply to the CPU 1201 is cut off in the sleep mode. However, this is not a limitation, and, for example, the power supply to the CPU 1201 may be reduced as compared to the normal mode.

In such a case, the processes that can be performed by the CPU 1201 become restricted in the sleep mode as compared to the normal mode. The processes that become restricted from being performed at least include processing of the data received by the network unit 1210 from a computer terminal on the LAN 3000.

Since the power supply control unit 1280 is supplying power to the RAM 1202 even when the image forming apparatus 100 is in the sleep mode, the RAM 1202 performs a self-refresh operation and backs up the system program in the sleep mode.

The process performed when the image forming apparatus 100 recovers from the sleep mode to the normal mode will be described in detail below. When the network unit 1210 receives the print job from the client PC 110, the network unit 1210 analyzes whether there is a data sequence corresponding to a physical address that is unique to the image forming apparatus 100, included in a packet received as the print job.

If the network unit 1210 detects the data sequence corresponding to the image forming apparatus 100, the network unit 1210 controls the power supply control unit 1280 via the control signal line 1285 to switch on the power supply line 1282. The network unit 1210 thus activates the CPU 1201.

The CPU 1201 then determines whether the CPU 1201 has been activated due to the image forming apparatus 100 recovering from the sleep mode to the normal mode, based on the operation of the power supply control unit 1280. If the CPU 1201 determines that the CPU 1201 has been activated due to the image forming apparatus 100 recovering from the sleep mode to the normal mode, the CPU 1201 starts an activation sequence.

Upon starting the activation sequence, the CPU 1201 omits the sequence for downloading the system program from the HDD 1204 to the RAM 1202 and uses the system program backed up in the RAM 1202 when the image forming apparatus 100 has shifted to the sleep mode. As a result, the controller 1200 which has shifted to the normal mode responds to the print job from the client PC on the LAN 3000, and controls the printer unit 20 to start printing.

According to the above-described process, the network unit 1210 switches the power supply mode from the sleep mode to the normal mode. However, this is not a limitation. More specifically, the modem unit 1211 or the operation unit I/F 1206 in addition to the network unit 1210 may switch the power supply mode from the sleep mode to the normal mode.

More specifically, upon detecting that a facsimile is received from the public line 3001 when the image forming apparatus 100 is in the sleep mode, the modem unit 1211 may perform control to switch the power supply mode from the sleep mode to the normal mode. Further, upon detecting that the user has pressed the power save key 65 in the operation unit 60 when the image forming apparatus 100 is in the sleep mode, the operation unit I/F 1206 may perform control to switch the power supply mode from the sleep mode to the normal mode.

Furthermore, when the image forming apparatus 100 actually switches from the sleep mode to the normal mode, or from the normal mode to the sleep mode, the image forming apparatus 100 performs the process for measuring or estimating the power consumption along with the shifting process. The control performed for measuring or estimating the power consumption will be described below with reference to the flowcharts.

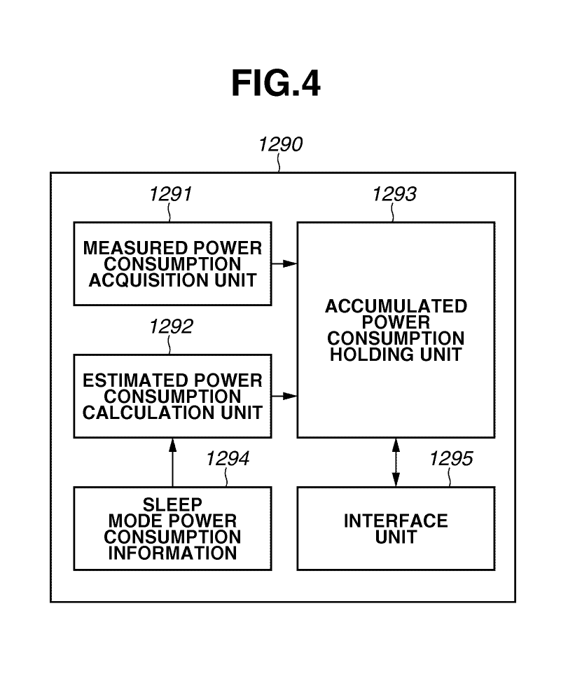

FIG. 4 is a block diagram illustrating an example of a software configuration of the power consumption management program 1290 executed by the image forming apparatus according to the first exemplary embodiment.

The power consumption management program 1290 illustrated in FIG. 4 is stored in the HDD 1204 (i.e., recorded to be readable by a computer). The HDD 1204 also stores a job management/control program that performs the above-described print job, and a power supply management/control program that performs shifting to and recovering from the sleep mode (i.e., the power saving function).

When the CPU 1201 executes a boot program, the power consumption management program 1290 is read from the HDD 1204 to the RAM 1202. The CPU 1201 then executes the read program on the RAM 1202, so that the process is performed.

Referring to FIG. 4, the power consumption management program 1290 includes a measured power consumption acquisition unit 1291 that acquires the power consumption amount of the image forming apparatus 100 from the power measurement unit 30. More specifically, the measured power consumption acquisition unit 1291 requests the printer unit 20 via the internal communication I/F 1208 for power consumption information based on the power consumption measured by the power measurement unit 30. The measured power consumption acquisition unit 1291 then stores the power consumption information acquired from the printer unit 20 in an accumulated power consumption holding unit 1293.

The above-described process for acquiring the measured power consumption is performed only when the image forming apparatus 100 has not shifted to the sleep mode, as will be described in detail below.

An estimated power consumption calculation unit 1292 estimates and calculates the power consumption of the image forming apparatus 100 in the sleep mode. When the image forming apparatus 100 is in the sleep mode, the power supply unit 40 supplies power only to the power supply line 1283 in the controller 1200, and not to the printer 20 and the CPU 1201 as described above, to maintain the low power consumption state. As a result, the power consumption information cannot be acquired using the power measurement unit 30.

The estimated power consumption calculation unit 1292 thus stores in the RAM 1202 the time at which the image forming apparatus 100 has shifted to the sleep mode. The estimated power consumption calculation unit 1292 then acquires a sleep period (i.e., the elapsed time between the image forming apparatus shifting to the sleep mode and recovering to the normal mode) when the image forming apparatus 100 recovers from the sleep mode. The estimated power consumption calculation unit 1292 thus estimates and calculates the power consumption during the sleep mode, using sleep mode power consumption information 1294.

More specifically, the estimated power consumption calculation unit 1292 multiplies the sleep period and the sleep mode power consumption information 1294. The power consumption of the image forming apparatus 100 in the sleep mode is thus estimated.

By using the above-described estimated power consumption calculation unit 1292, the power consumption of the image forming apparatus 100 in the power saving mode can be estimated, without the image forming apparatus 100 consuming power for measuring the power consumption in the power saving mode.

The sleep mode power consumption information 1294 is a numerical value indicating the consumed power per unit time in the image forming apparatus 100 in the sleep mode. The sleep mode power consumption information 1294 is acquired by measuring the consumed power per unit time in the sleeping mode by performing an experiment, or calculating logical values, and is stored in the HDD 1204.

The image forming apparatus 100 in the sleep mode is in the static state (i.e., each device is not operating). A deviation in the stored value from the actual consumed power value, such as an individual difference, is thus rarely generated in the power consumption per unit time in the sleep mode.

As a result, the power consumption in the sleep mode can be accurately estimated and calculated by referring to the previously acquired value of the power consumption per unit time in the sleep mode (i.e., the sleep mode power consumption information 1294).

The accumulated power consumption holding unit 1293 adds and stores the value of the power consumption acquired by the measured power consumption acquisition unit 1291 (i.e., the power consumption in the normal mode) and the value of the power consumption that is estimated and calculated by the estimated power consumption calculation unit 1292 (i.e., the power consumption in the sleep mode). In other words, the accumulated power consumption holding unit 1293 stores the total amount of power consumed in the image forming apparatus 100 in the sleep mode and the normal mode.

An interface unit 1295 displays on the liquid crystal operation panel 61 in the operation unit 60 the total power consumption stored in the accumulated power consumption holding unit 1293. The interface unit 1295 also performs control to output to the client PC 110 and the other external devices connected to the LAN 3000 via the network unit 1210, the total power consumption stored in the accumulated power consumption holding unit 1293.

As described above, the image forming apparatus estimates and calculates the power consumption in the sleep mode instead of measuring the power consumption in the sleep mode. As a result, the power consumption in the sleep mode can be acquired by estimation and calculation while maintaining the power saving state without consuming power to measure the power consumption in the sleep mode.

As described above, the power consumption of the image forming apparatus can be appropriately acquired using the power consumption actually measured in the normal mode and the power consumption estimated in the sleep mode. The power consumption can thus be acquired while reducing the percentage of the power consumed in measuring the power consumption.

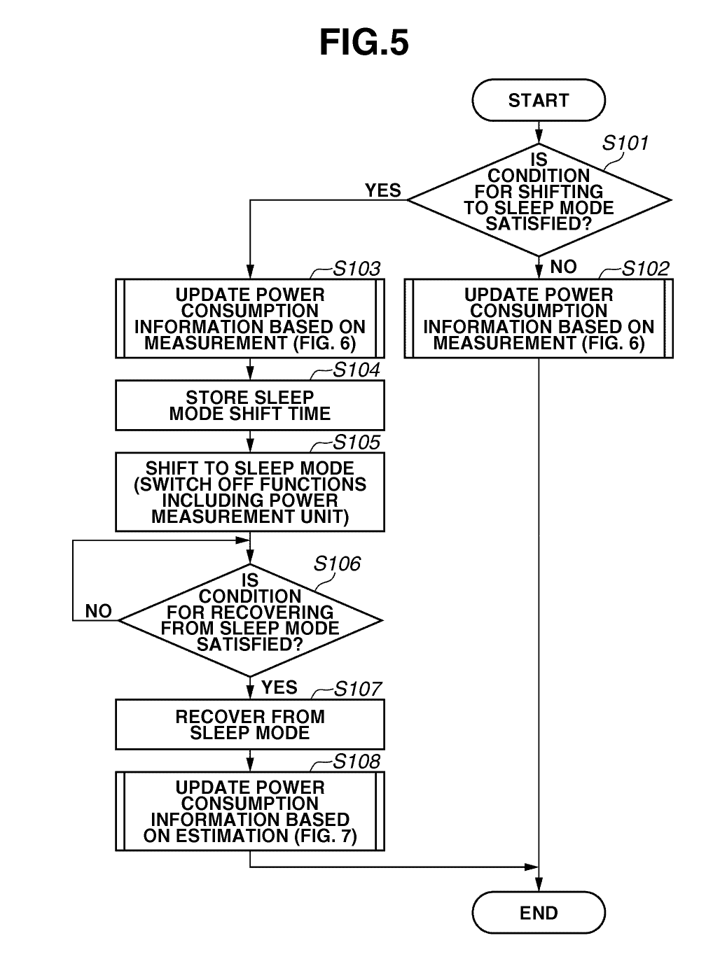

The operation performed in the image forming apparatus for measuring and calculating the power consumption, and shifting and recovering from the sleep mode will be described below with reference to FIGS. 5, 6, and 7.

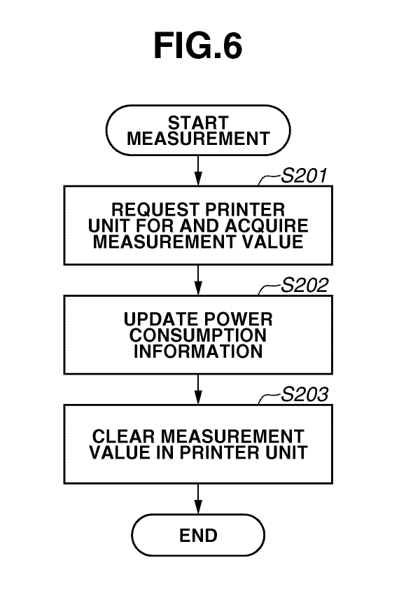

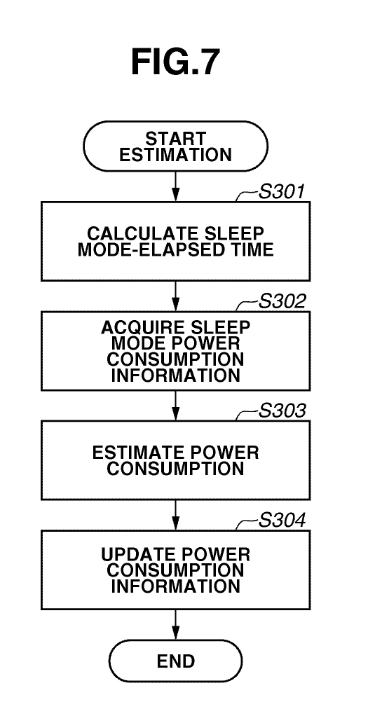

FIG. 5 is a flowchart illustrating a process performed in the image forming apparatus for measuring and calculating the power consumption, and shifting and recovering from the sleep mode according to the first exemplary embodiment. FIG. 6 is a flowchart illustrating an example of a process for updating power consumption information based on measurement. FIG. 7 is a flowchart illustrating an example of a process for updating power consumption information based on an estimation operation.

The processes illustrated in the flowcharts of FIGS. 5, 6, and 7 are realized by the CPU 1201 in the controller 1200 reading and executing the computer-readable programs recorded in the HDD 1204. Further, the process illustrated in the flowchart of FIG. 5 is repeatedly executed at an arbitrary time interval.

In step S101 illustrated in FIG. 5, the CPU 1201 determines whether a condition for shifting to the sleep mode has been satisfied. More specifically, the condition for shifting to the sleep mode indicates the condition for shifting the image forming apparatus 100 to the sleep mode which is one of the power saving modes.

An example of the condition for shifting to the sleep mode is “an operation instruction such as the print job is not issued to the image forming apparatus 100 in the normal mode for a predetermined time or longer”. Further, the user not operating on the operation unit 60 for a predetermined time or longer may also be included in the condition. If the CPU 1201 determines that the condition is not satisfied (NO in step S101), the process proceeds to step S102.

In step S102, the CPU 1201 updates the power consumption information based on measurement, and then ends the process of the flowchart. The specific content of the process performed in step S102 will be described below with reference to FIG. 6. As a result of performing such a process, the power consumption information in the accumulated power consumption holding unit 1293 is appropriately updated based on the measurement value.

On the other hand, if the CPU 1201 determines that the condition for shifting the image forming apparatus 100 to the sleep mode is satisfied (YES in step S101), the process proceeds to step S103.

In step S103, the CPU 1201 updates the power consumption information based on measurement to prepare for the image forming apparatus shifting to the sleep mode. The process is similar to the process performed in step S102, and will be described in detail with reference to FIG. 6.

If the process illustrated in FIG. 5 is executed at predetermined time intervals, there is an interval of time between execution of the process of step S102 to when the condition for shifting to the sleep mode is satisfied. However, the power consumption information during such interval of time is appropriately reflected in the accumulated power consumption holding unit 1293 by performing the process of step S103. In other words, the power consumption information until immediately before shifting to the sleep mode is appropriately reflected in the accumulated power consumption holding unit 1293 by performing the process of step S103.

In step S104, the CPU 1201 stores the time at which the image forming apparatus 100 shifts to the sleep mode. The CPU 1201 acquires the current time information and records the time information in a storage unit such as the RAM 1202 and the HDD 1204 which hold information even during the sleep mode. As a result, the time at which the image forming apparatus 100 has shifted to the sleep mode can be acquired after the image forming apparatus 100 recovers from the sleep mode.

In step S105, the CPU 1201 performs the process for shifting to the sleep mode. More specifically, the process for shifting to the sleep mode described above is performed, and the CPU 1201 in the controller 1200 controls the power supply unit 40.

The power supply unit 40 receives the instruction from the CPU 1201 and supplies power to only the controller 1200 via the power supply line 1281. The power supply unit 40 does not supply power to the scanner unit 10, the printer unit 20, the power measurement unit 30, and the operation unit 60. Further, as described above, the power is supplied only to the RAM 1202 and the portions that are related to the condition for recovering from the sleep mode in the controller 1200 (i.e., the operation unit I/F 1206, the network unit 1210, and the modem unit 1211).

In such a case, the power supply to the power measurement unit 30 which operates to measure the power, and the printer 20 is cut off, so that the power consumption in the sleep mode is greatly reduced. In other words, the power supply to the CPU 1201 is also stopped.

In step S106, the portions related to the condition for recovering from the sleep mode (i.e., the operation unit I/F 1206, the network unit 1210, and the modem unit 1211) determine whether the condition for recovering from the sleep mode has been satisfied. As described above, the condition for recovering from the sleep mode includes the network unit 1210 receiving the print job, the modem unit 1211 receiving the facsimile communication, or the operation unit I/F 1206 or the operation unit 60 detecting that the power save key 65 has been pressed.

If the condition for recovering from the sleep mode has not been satisfied (NO in step S106), the portions related to the condition for recovering from the sleep mode continues in step S106 to monitor whether the condition for recovering from the sleep mode has been satisfied.

On the other hand, if the condition for recovering from the sleep mode has been satisfied (YES in step S106), the portions related to the condition for recovering from the sleep mode control the power supply control unit 1280 via the control signal line 1285 to switch on the power supply line 1282. As a result, the power supply control unit 1280 restarts supplying power to the portion including the CPU 1201 in the controller 1200.

If the power is supplied to the CPU 1201 even when the image forming apparatus 100 is in the sleep mode (e.g., in the case where the power supplied to the CPU 1201 in the sleep mode is reduced as compared to the power supplied in the normal mode), the CPU 1201 may perform the determination process of step S106.

In step S107, the CPU 1201 that has again started to receive the power performs the process for recovering from the sleep mode. More specifically, the CPU 1201 executes the activation sequence using the system program that has been backed up in the RAM 1202, and instructs the power supply unit 40 to restart supplying power to each unit in the image forming apparatus 100. Upon receiving the instruction from the CPU 1201, the power supply unit 40 restarts supplying power to each unit in the image forming apparatus 100. As a result, the image forming apparatus 100 recovers to the normal mode.

In step S108, the CPU 1201 updates the power consumption information based on performing estimation operation, and then the process illustrated in the flowchart ends. The content of the process performed in step S108 will be described in detail below with reference to FIG. 7. As a result of performing the process of step S108, the power consumption information in the accumulated power consumption holding unit 1293 is appropriately updated based on the estimated value.

The process for updating the power consumption information based on measurement performed in step S102 and step S103 illustrated in FIG. 5 will be described in detail below with reference to FIG. 6.

In step S201, the CPU 1201 makes a request for the measurement value to the printer unit 20 and acquires it. The process is realized by executing the measured power consumption acquisition unit 1291 in the power consumption management program 1290.

The CPU (not illustrated) in the printer unit 20 continuously reads the voltage and the current output from the power measurement unit 30 at predetermined intervals, and accumulates the read values. The printer unit 20 thus transmits to the controller 1200 the accumulated values as power consumption information according to the request from the CPU 1201.

In step S202, the CPU 1201 updates the power consumption information in the accumulated power consumption holding unit 1293 based on the power consumption information acquired in step S201. The CPU 1201 updates the power consumption information by newly adding (accumulating) the power consumption information acquired in step S201 to the power consumption information stored in the accumulated power consumption holding unit 1293.

As a result, the accumulated power consumption holding unit 1293 constantly stores the latest power consumption information of the image forming apparatus 100 at constant intervals. The accumulated power consumption holding unit 1293 also stores each of the power consumption information acquired in step S201 associated with the acquisition date and time, in addition to the accumulated power consumption information.

In step S203, the CPU 1201 instructs the printer unit 20 to clear the power consumption information acquired by calculation. The power consumption information transmitted from the printer unit 20 thus becomes the information on the power consumed between the CPU 1201 issuing the previous request for information and the current request for information to the printer unit 20. After performing the process of step S203, the process returns to the process illustrated in the flowchart of FIG. 5.

All of the communications between the controller 1200 and the printer unit 20 performed in step S201 to step S203 illustrated in FIG. 6 is performed via the internal communication I/F 1208.

The process for updating the power consumption information based on estimation operation performed in step S108 illustrated in FIG. 5 will be described in detail below with reference to FIG. 7.

In step S301, the CPU 1201 acquires by calculation the time that has actually elapsed in the sleep mode. The CPU 1201 executes the estimated power consumption calculation unit 1292 in the power consumption management program 1290 to perform the calculation. More specifically, the CPU 1201 reads the time at which the image forming apparatus 100 has shifted to the sleep mode, stored in the RAM 1202 in step S104 illustrated in FIG. 5. The CPU 1201 then compares the read time with the current time information, and acquires the time that has elapsed in the sleep mode.

In step S302, the CPU 1201 acquires from the sleep mode power consumption information 1294 the information on the amount of power consumed per unit time by the image forming apparatus 100 in the sleep mode.

In step S303, the CPU 1201 estimates the power consumption in the sleep mode. More specifically, the CPU 1201 multiplies the time that has elapsed in the sleep mode acquired in step S301 and the information on the amount of power consumed per unit time in the sleep mode acquired in step S302. The CPU 1201 thus estimates the amount of power consumed in the sleep mode. As described above, it is assumed that there is little deviation between the estimated value and the actual power consumption in the static state such as in the sleep mode.

In step S304, the CPU 1201 updates the power consumption information in the accumulated power consumption holding unit 1293 based on the power consumption information acquired by performing estimation operation in step S303. The CPU 1201 updates the information by newly adding (accumulating the information) power consumption estimated in step S303 to the power consumption information stored in the accumulated power consumption holding unit 1293.

As a result, the accumulated power consumption holding unit 1293 holds the information on the latest total power consumption including the power consumption in the sleep mode. The accumulated power consumption holding unit 1293 also holds each of the power consumption information estimated in step S303 associated with the date and time of the estimation. After the CPU 1201 ends the process of step S304, the process returns to the flowchart illustrated in FIG. 5.

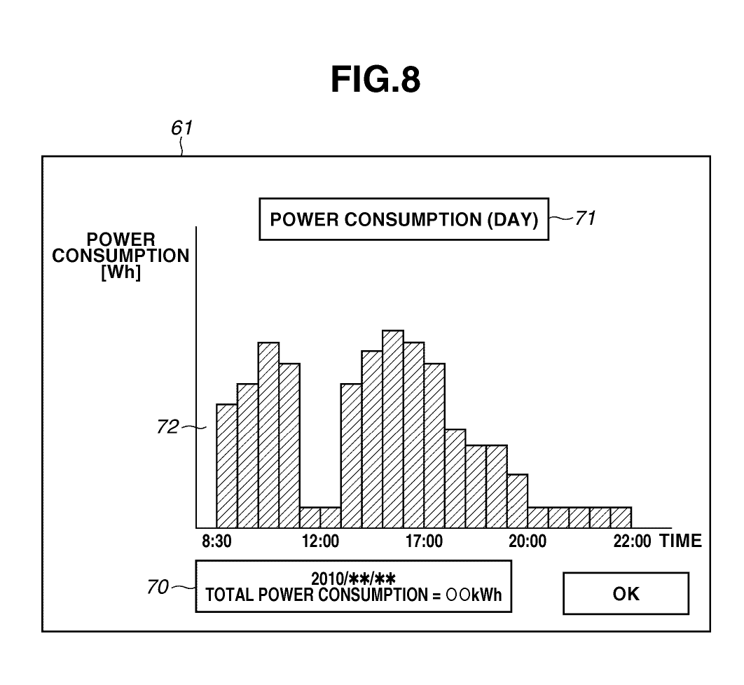

FIG. 8 illustrates an example of a display screen that displays the power consumption information in the image forming apparatus. When the user operates on the operation unit 60, the CPU 1201 performs display control to display the display screen on the liquid crystal panel 61.

Referring to FIG. 8, a title 71 indicates the content of the display. According to the present display example, the information on the power consumption for one day is displayed as a graph, so that “power consumption (day)” is displayed as the title 71. A box 70 indicates the total power consumption in a displayed period. A power consumption graph 72 displays a graph of the power consumption during a period according to an instruction received from the user. In the present example, the consumed power per unit is indicated on the vertical axis of the graph, and time is indicated on the horizontal axis of the graph.

When the CPU 1201 is notified via the operation unit I/F 1206 of a display request from the user operating on the operation unit 60, the CPU 1201 displays the display screen. More specifically, the display screen is displayed by the CPU 1201 executing the interface unit 1295 in the power consumption management program 1290.

The user may instruct by operating on the operation unit 60 the type and the settings of the axes of the graph, and the data range to be displayed on the display screen. In response to the instruction, the CPU 1201 acquires the data stored in the accumulated power consumption holding unit 1293, and processes the acquired data as necessary. The CPU 1201 then generates the display screen including the power consumption information corresponding to the user instruction, and performs display control to display the display screen on the liquid crystal operation panel 61.

The example illustrated in FIG. 8 displays as a bar graph, each of the data corresponding to the designated date stored in the accumulated power consumption holding unit 1293, accumulated for each hour. The example is also displayed as a bar graph by generating the data averaged for each hour within the designated range (e.g., one month).

According to the present exemplary embodiment, the display screen is displayed on the liquid crystal operation panel 61 in the operation unit 60. However, the display screen may be displayed on the display unit of an external device on the LAN 3000 such as the client PC 110 via the network unit 1210 by receiving a request from the external device.

As a result of the above-described configuration, the power consumption in the image processing apparatus can be appropriately acquired while reducing the power consumed in measuring the power consumption.

The power consumption information stored in the accumulated power consumption holding unit 1293 may be cleared by the user operating the operation unit 60, or from the external device such as the client PC 110 via the network unit 1210. Further, the CPU 1201 may clear the power consumption information stored in the accumulated power consumption holding unit 1293 at regular intervals.

According to the first exemplary embodiment, the power consumption of the image forming apparatus in the sleep mode is acquired based on estimation. According to a second exemplary embodiment, an external server of the image forming apparatus estimates the power consumption of the image forming apparatus in the sleep mode. Further, the external server manages the accumulated power consumption of the image forming apparatus.

The server in such a configuration thus becomes capable of displaying the power consumption information of the image forming apparatus even when the user issues a request to display the accumulated power consumption up to the present while the image forming apparatus is in the sleep mode. The information can be displayed without recovering the image forming apparatus from the sleep mode. Further, the server becomes capable of collectively managing the power consumption information of a plurality of image forming apparatuses.

The difference between the first exemplary embodiment and the present exemplary embodiment will be described in detail below by referring to the drawings.

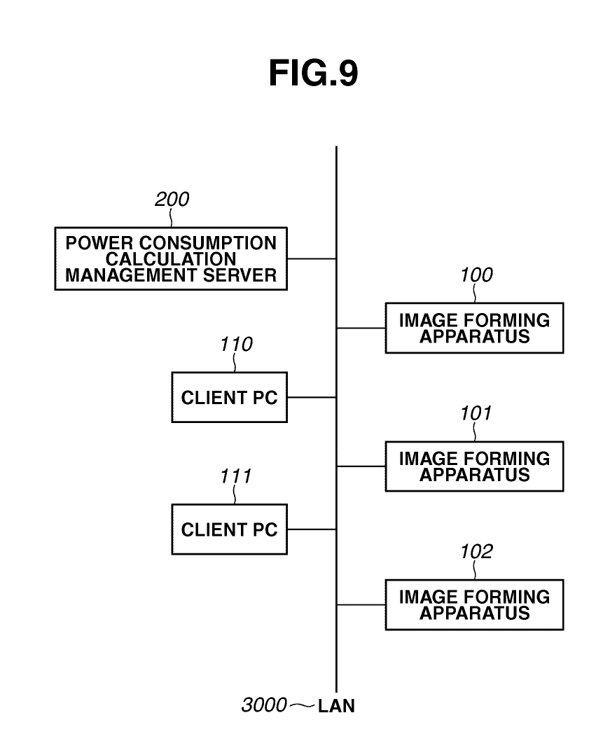

FIG. 9 illustrates a configuration example of a network system that mainly manages power consumption information of one or a plurality of image forming apparatuses, by applying an electronic device management system according to the present exemplary embodiment.

Referring to FIG. 9, the system includes the client PCs 110 and 111, the image forming apparatuses 100, 101, and 102, and a power consumption calculation management server 200. The client PCs 110 and 111, the image forming apparatuses 100, 101, and 102, and the power consumption calculation management server 200 are each connected to the LAN 3000 to be communicable with each other.

The example illustrated in FIG. 9 is a configuration in which the power consumption calculation management server 200 manages the power consumption of the plurality of the image forming apparatuses. However, the electronic devices whose power consumption is managed by the power consumption calculation management server 200 are not limited to image forming apparatuses.

Further, the power consumption calculation management server 200 may manage the power consumption of an electronic device group including electronic devices having a function for realizing power saving. Such an electronic device realizes power saving by switching between the normal mode and the power save mode (hereinafter referred to as the sleep mode).

The hardware configuration of the power consumption calculation management server 200 will be described below.

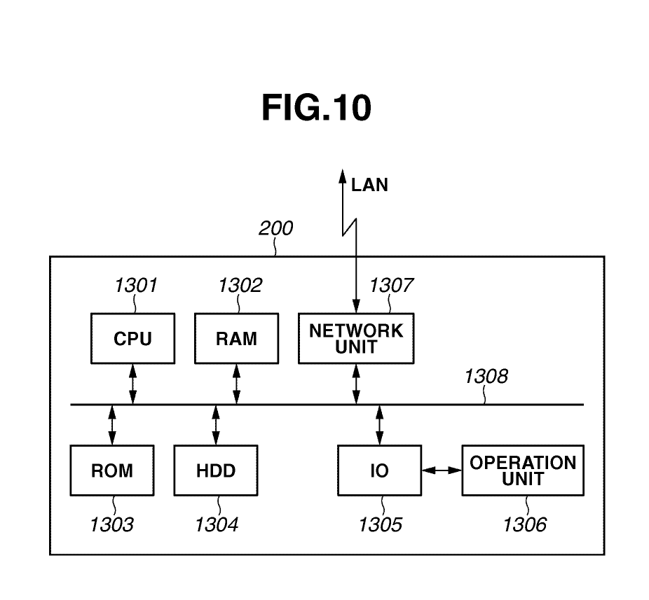

FIG. 10 is a block diagram illustrating an example of a hardware configuration of the power consumption calculation management server 200.

Referring to FIG. 10, the power consumption calculation management server 200 includes a CPU 1301, a RAM 1302, a ROM 1303, an HDD 1304, a network unit 1307, an input/output (IO) unit 1305, and an operation unit 1306, which are connected to each other by a system bus 1308.

The CPU 1301 provides various functions by reading from the HDD 1304 and executing the programs such as an operating system (OS) or application software. Further, the CPU 1301 collectively controls the power consumption calculation management server management process performed by the power consumption calculation management server 200. The RAM 1302 is a system work memory to be used when the CPU 1301 executes the programs. The ROM 1303 records a basic input output system (BIOS), the program for activating the OS, or setting files to be readable by the computer.

The HDD 1304 is a hard disk drive and records the system software and the programs to be readable by the computer for realizing the processes to be described below. Such programs may be recorded to be readable by the computer and distributed in a compact disk (CD), a digital versatile disk (DVD), or a flash memory. The programs may also be downloaded from a predetermined server connected via the LAN 3000 and installed in the HDD 1304.

The network unit 1307 is connected to the LAN 3000 and communicates with (i.e., performs transmission and reception therebetween) the external devices such as the client PCs 110 and 111 and the image forming apparatuses 100, 101, and 102. The IO unit 1305 is an interface for inputting and outputting information to and from the operation unit 1306.

The operation unit 1306 includes input and output devices (not illustrated) such as a liquid crystal display (LCD) and a mouse. Predetermined information is drawn on the LCD at a predetermined resolution and using a predetermined number of colors, based on display information instructed by the program. For example, the LCD forms a graphical user interface (GUI) screen, and displays various windows and buttons necessary for operating the screen and the data.

The hardware configuration of the client PCs 110 and 111 are similar to the above-described configuration of the power consumption calculation management server 200.

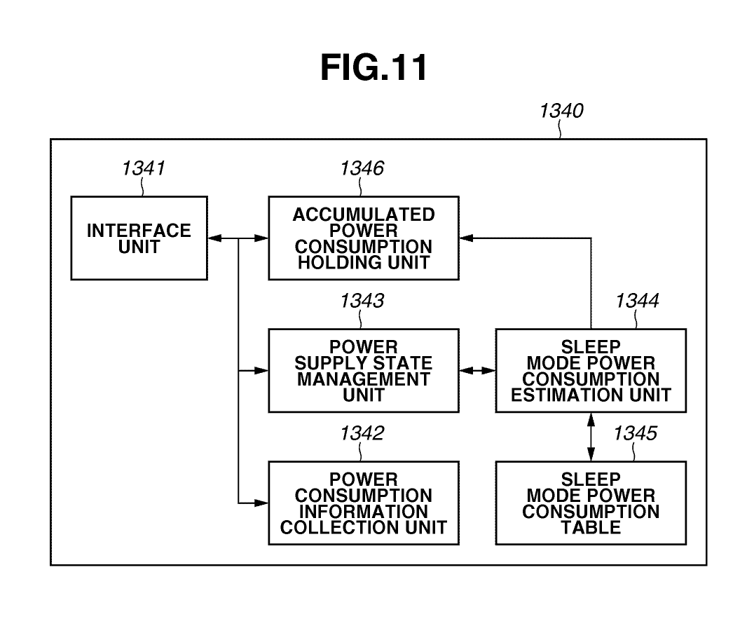

FIG. 11 illustrates an example of a power consumption calculation management program 1340 executed by the power consumption calculation management server 200.

Referring to FIG. 11, the power consumption calculation management program 1340 is stored (i.e., recorded to be readable by the computer) in the HDD 1304 as a function to be realized by the power consumption calculation management server 200. The CPU 1301 executes the boot program and reads the power consumption calculation management program 1340 from the HDD 1304 to the RAM 1302. The CPU 1301 then executes the program read on the RAM 1302, and thus performs the process.

Each program included in the power consumption calculation management program 1340 will be described below. An interface unit 1341 performs control for accessing via the network unit 1307 the external devices such as the client PCs 110 and 111 and the image forming apparatuses 100, 101, and 102 connected on the LAN 3000. The interface unit 1341 performs the access control according to the instruction from functional units to be described below.

An interface unit 1341 displays on the LCD of the operation unit 1306 via the IO unit 1305, the information about the total power consumption of each image forming apparatus stored in an accumulated power consumption holding unit 1346.

A power consumption information collection unit 1342 collects the power consumption information of each image forming apparatus on the LAN 3000. More specifically, the power consumption information collection unit 1342 transmits via the interface unit 1341 an acquisition request for the power consumption information regularly measured in the image forming apparatus. The power consumption information collection unit 1342 thus collects the power consumption information.

The acquisition request of the power consumption information measured in the image forming apparatus is executed only with respect to the image forming apparatus not having shifted to the sleep mode. Further, the accumulated power consumption storage unit 1345 adds, stores, and manages for each image forming apparatus the collected power consumption information measured in the image forming apparatus.

A power supply state management unit 1343 manages the power supply state of each image forming apparatus on the LAN 3000. The power supply state indicates whether the state of each image forming apparatus is the sleep mode or the normal mode.

According to the present exemplary embodiment, when the image forming apparatus shifts to the sleep mode, each image forming apparatus transmits the information on shifting to the sleep mode to the power consumption calculation management server 200. Further, when the image forming apparatus recovers from the sleep mode to the normal mode, each image forming apparatus transmits the information on recovering from the sleep mode to the power consumption calculation management server 200.

The power supply state management unit 1343 manages the above-described information for each image forming apparatus. The power supply state management unit 1343 thus acquires whether each image forming apparatus on the LAN 3000 is currently in the sleep mode or the normal mode.

A sleep mode power consumption estimation unit 1344 estimates, when the image forming apparatus on the LAN 3000 is in the sleep mode, the power consumption in the sleep mode.

More specifically, the sleep mode power consumption estimation unit 1344 acquires, when an image forming apparatus recovers from the sleep mode, information about the time that has elapsed while the image forming apparatus is in the sleep mode. The sleep mode power consumption estimation unit 1344 then acquires from a sleep mode power consumption table 1345 the consumed power per unit time when the image forming apparatus is in the sleep mode.

Further, the sleep mode power consumption estimation unit 1344 multiplies the acquired elapsed time and the consumed power per unit time, and thus estimates and calculates the power consumption when the image forming apparatus is in the sleep mode.

The sleep mode power consumption estimation unit 1344 may also perform the estimation operation when the user requests via the operation unit 1306 for the power consumption to be displayed, in addition to when the image forming apparatus recovers from the sleep mode.

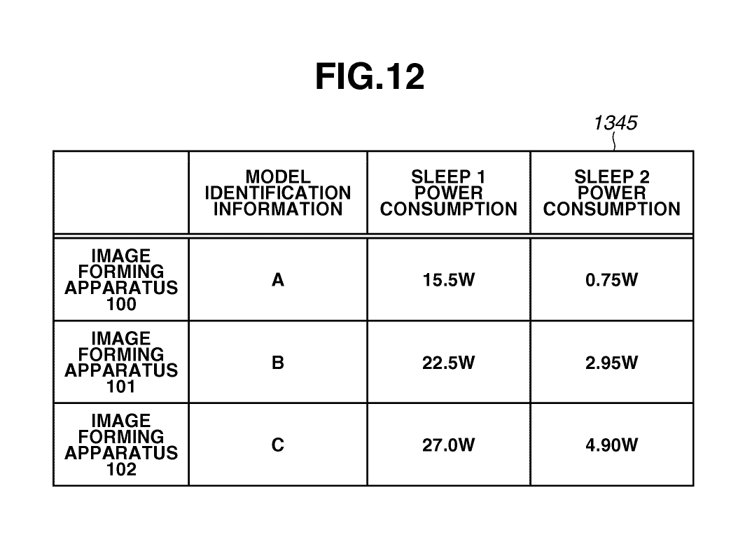

The sleep mode power consumption table 1345 stores numerical values indicating the consumed power per unit time during the sleep mode for each image forming apparatus. The numerical values are acquired by previously measuring by performing an experiment, the consumed power per unit time of the corresponding image forming apparatus in the sleep mode, or by calculating using logical values. This is similar to the first exemplary embodiment. The numerical values are stored for each image forming apparatus as illustrated in FIG. 12.

FIG. 12 illustrates an example of the sleep mode power consumption table 1345. According to the present exemplary embodiment, each image forming apparatus includes two types of sleep modes, i.e., sleep 1 and sleep 2. Sleep 2 indicates the sleep mode described in detail in the first exemplary embodiment. Sleep 1 is a state in which a power supplying range is wider as compared to the sleep mode according to the first exemplary embodiment (hereinafter referred to as sleep 2). Sleep 1 thus indicates a state in which the image forming apparatus is capable of performing a larger number of processes as compared to sleep 2.

For example, sleep modes may be set so that the power supplied to the CPU 1201 is reduced as in the normal mode in sleep 1, whereas power supply to the CPU 1201 is cut off in sleep 2.

The sleep mode power consumption table 1345 manages model identification information for identifying the model of each of the image forming apparatuses 100, 101, and 102 on the LAN 3000. Further, the sleep mode power consumption table 1345 manages the consumed power values per unit time when each image forming apparatus is in sleep 1 (i.e., sleep 1 power consumption), and in sleep 2 (i.e., sleep 2 power consumption).

An accumulated power consumption holding unit 1346 holds for each image forming apparatus a sum of the values of the power consumption of the image forming apparatus, acquired by the power consumption information collection unit 1342 and estimated by the sleep mode power consumption estimation unit 1344. As a result, the accumulated power consumption holding unit 1346 stores for each image forming apparatus, the total amount of power consumed when the image forming apparatus is in the sleep mode and in the normal mode.

The hardware configuration of the image forming apparatuses 100, 101, and 102 according to the second exemplary embodiment is similar to those illustrated in FIG. 1 according to the first exemplary embodiment. Further, the configurations of the power measurement unit and the operation unit according to the second exemplary embodiment are similar to those illustrated in FIG. 2 and in FIG. 3 respectively according to the first exemplary embodiment. The content of the power consumption management program in the image forming apparatus according to the second exemplary embodiment is different from that according to the first exemplary embodiment.

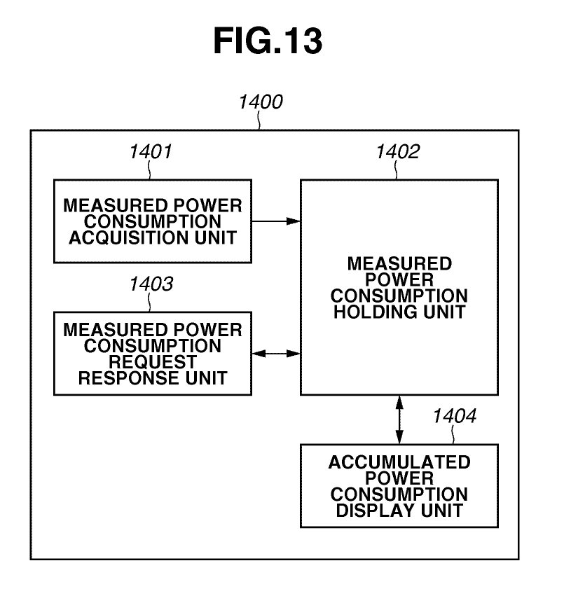

A power consumption management program 1400 in each of the image forming apparatus according to the second exemplary embodiment will be described below with reference to FIG. 13.

FIG. 13 is a block diagram illustrating an example of the software configuration of the power consumption management program 1400 executed in each image forming apparatus according to the second exemplary embodiment.

The power consumption management program 1400 illustrated in FIG. 13 is stored in the HDD 1204 (i.e., recorded to be readable by the computer). The HDD 1204 stores the job management/control program for executing the print job, and the power management/control program that performs processes for shifting to and recovering from the sleep mode.

When the CPU 1201 in each image forming apparatus executes the boot program, the CPU 1201 reads the power consumption management program 1400 from the HDD 1204 to the RAM 1202. The CPU 1201 in each image forming apparatus then executes the program in the RAM 1202 to perform the process.

Each of the programs included in the power consumption management program 1400 will be described below.

Referring to FIG. 13, a measured power consumption acquisition unit 1401 acquires from the power measurement unit 30 the power consumption in the image forming apparatus. More specifically, the measured power consumption acquisition unit 1401 requests for and acquires from the printer unit 20 via the internal communication I/F 1208, the power consumption information based on the power consumption measured by the power measurement unit 30. The measured power consumption acquisition unit 1401 then stores the acquired power consumption information in a measured power consumption holding unit 1402. This is similar to the first exemplary embodiment.

The measured power consumption acquisition unit 1401 acquires the measured power consumption at regular intervals only when the image forming apparatus has not shifted to the sleep mode as will be described in detail below.

The measured power consumption holding unit 1402 holds the accumulated values of the power consumption acquired by the measured power consumption acquisition unit 1401. The measured power consumption holding unit 1402 thus holds the total power consumption of the image forming apparatus in the normal mode.

A measured power consumption request response unit 1403 performs control to respond to a request from the power consumption information collection unit 1342 in the power consumption calculation management server 200.

More specifically, the power consumption information collection unit 1342 in the power consumption calculation management server 200 requests the measured power consumption request response unit 1403 for the power consumption information. The measured power consumption request response unit 1403 then reads the value of the measured power consumption stored in the measured power consumption holding unit 1402 according to the request. The measured power consumption request response unit 1403 then transmits the read value to the power consumption calculation management server 200 (power consumption notification process). As a result, the power consumption calculation management server 200 can acquire and manage the measured power consumption in the image forming apparatus.

After the measured power consumption request response unit 1403 reads and transmits to the power consumption calculation management server 200 the value of the power consumption stored in the measured power consumption holding unit 1402 (accumulated value), the stored value is cleared.

Further, the measured power consumption request response unit 1403 performs an operation mode shift notification process. More specifically, the measured power consumption request response unit 1403 transmits to the power consumption calculation management server 200 an operation mode shift notification indicating that the image forming apparatus has shifted from the normal mode to the power save mode, or from the power save mode to the normal mode.

An accumulated power consumption display unit 1404 displays on the operation unit 60 the accumulated power consumption of the image forming apparatus, according to the user operation on the operation unit 60. More specifically, the accumulated power consumption display unit 1404 accesses the power consumption calculation management server 200 via the network unit 1210. The accumulated power consumption display unit 1404 then acquires the accumulated power consumption including the power consumption of the image forming apparatus in the sleep mode, and displays the acquired amount on the operation unit 60. The accumulated power consumption display unit 1404 displays the content similar to that according to the first exemplary embodiment (e.g., FIG. 8).

As described above, there are two types of sleep modes, i.e., sleep 1 and sleep 2, according to the second exemplary embodiment.

Sleep 2 indicates the sleep mode described in detail in the first exemplary embodiment, and when the image forming apparatus shifts to or recovers from the sleep mode, the power is similarly supplied as in the first exemplary embodiment. Further, sleep 1 indicates a state in which the power is supplied to the power supplying line 1282, in addition to the sleep mode according to the first exemplary embodiment. The power supplying process performed when the image forming apparatus shifts to or recovers from the sleep mode is similar to that of the first exemplary embodiment other than the above-described difference.

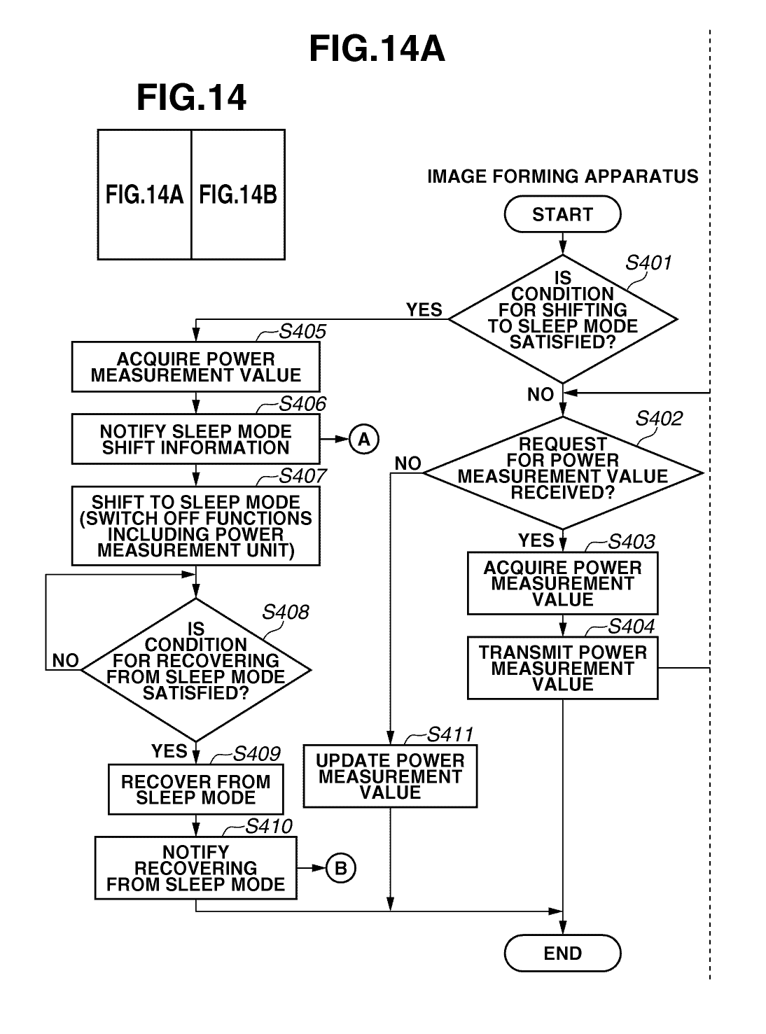

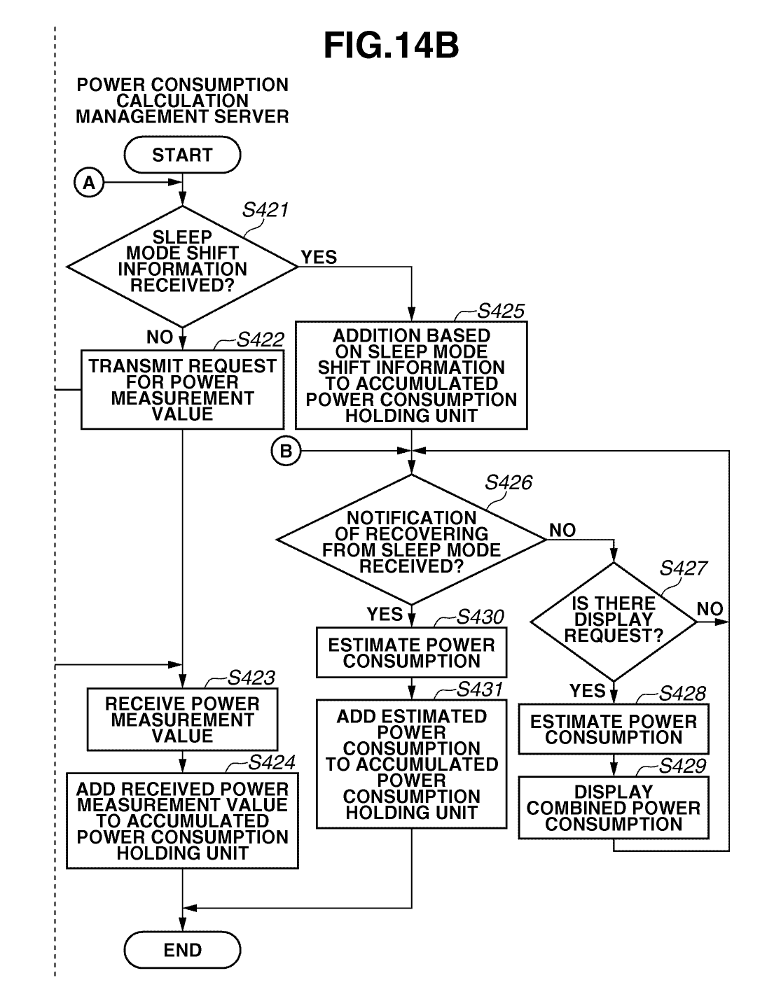

Furthermore, when the image forming apparatus actually shifts from the sleep mode to the normal mode, or from the normal mode to the sleep mode, both the image forming apparatus and the power consumption calculation management server perform the process related to the power consumption. The process is performed along with the shifting process. The control for performing such processes is different from that of the first exemplary embodiment, as will be described below with reference to the flowchart illustrated in FIG. 14 (14A and 14B).

The process for controlling the power consumption calculation management of the system according to the second exemplary embodiment will be described below with reference to FIG. 14.

FIG. 14 is a flowchart illustrating a process performed by the image processing apparatuses 100, 101, and 102, and the power consumption calculation management server 200 according to the second exemplary embodiment. The present exemplary embodiment is different from the first exemplary embodiment in that the process illustrated in FIG. 14 is performed by the image processing apparatuses 100, 101, and 102, and the power consumption calculation management server 200.

The CPU 1201 in the controller 1200 performs the processes of step S401 to step S411 illustrated in FIG. 14 by reading and executing the computer-readable program recorded in the HDD 1204.

Further, the CPU 1301 in the power consumption calculation management server 200 performs the processes of step S421 to step S431 illustrated in FIG. 14 by reading and executing the computer-readable program recorded in the HDD 1304. Furthermore, the process illustrated in the flowchart of FIG. 14 is repeatedly performed at predetermined time intervals.

The process performed by the image forming apparatus will be described below. In step S401, the CPU 1201 in the image forming apparatus determines whether the condition for shifting to the sleep mode has been satisfied. The condition for shifting to the sleep mode indicates the condition for the image forming apparatus to shift to sleep 1 or sleep 2. An example of such a condition is “an operation instruction such as a print job is not issued to each image forming apparatus in the normal mode for a predetermined period or longer.”

Further, the user not operating on the operation unit 60 for a predetermined time or longer may also be included in the condition. If the CPU 1201 determines that the condition is not satisfied (NO in step S401), the process proceeds to step S402.

In step S402, the CPU 1201 determines whether a request is received from the power consumption calculation management server 200. If the CPU 1201 determines that the request has been received (YES in step S402), the process proceeds to step S403.

In step S403, the CPU 1201 acquires the power measurement value requested from the power consumption calculation management server 200. The power measurement value is an accumulated value of the measured power consumption stored in the measured power consumption holding unit 1402.

In step S404, the CPU 1201 transmits to the power consumption calculation management server 200 the power measurement value acquired in step S403. In such a case, the CPU 1201 adds the model identification information to the transmission data so that the power consumption calculation management server 200 can identify the model of the image forming apparatus.

The CPU 1201 performs the processes of step S402 to step S404 by executing the measured power consumption request response unit 1403 in the power consumption management program 1400. After completing the process of step S404, the CPU 1201 ends the process performed by the image forming apparatus.

On the other hand, if the CPU 1201 determines that the request has not been received from the power consumption calculation management server 200 (NO in step S402), the process proceeds to step S411.

In step S411, the CPU 1201 updates the power measurement value. More specifically, the CPU 1201 executes the measured power consumption acquisition unit 1401. The CPU 1201 then requests for the value of the measured power consumption and acquires it from the printer unit 20. The CPU 1201 adds the acquired value to the measured power consumption holding unit 1402, and ends the process of the flowchart.

On the other hand, if the CPU 1201 determines that the condition for shifting to the sleep mode has been satisfied (YES in step S401), the process proceeds to step S405. In step S405, the CPU 1201 acquires from the measured power consumption holding unit 1402 the power measurement value similarly as in step S403, to prepare for shifting to the sleep mode.

In step S406, the CPU 1201 notifies the power consumption calculation management server 200 of the information for shifting to the sleep mode, including whether the image forming apparatus is to shift to sleep 1 or sleep 2. The content of the notification includes the power measurement value acquired in step S405 and the model identification information.

As a result of performing such a process, the power consumption calculation management server 200 can accurately acquire the time at which the image forming apparatus shifts to the sleep mode. Further, the information about the amount of power consumed in the image forming apparatus until immediately before shifting to the sleep mode is appropriately transmitted to the power consumption calculation management server 200.

In step S407, the CPU 1201 performs the process for shifting the image forming apparatus to the sleep mode. More specifically, the CPU 1201 performs the sleep mode shifting process (illustrated in step S105 in FIG. 5) described according to the first exemplary embodiment. As a result, the image forming apparatus shifts to the sleep mode, and the power is stopped from being supplied to the CPU 1201.

In step S408, the portions related to the condition for recovering from the sleep mode (i.e., operation unit I/F 1206, the network unit 1210, and the modem unit 1211) determine whether the condition for the image forming apparatus to recover from the sleep mode has been satisfied.

The examples of the condition for recovering from the sleep mode as described above are the network unit 1210 receiving the print job, the modem unit 1211 receiving a facsimile, and the operation unit I/F 1206 or the operation unit 60 detecting that the power save key 65 has been pressed.

If the condition for the image forming apparatus to recover from the sleep mode is not satisfied (NO in step S408), the portions related to the condition continue to monitor in step S408 whether the condition has been satisfied.

On the other hand, if the condition for the image forming apparatus to recover from the sleep mode is satisfied (YES in step S408), the portions related to the condition controls the power supply control unit 1280 via the control signal line 1285 to switch on the power supply line 1282. The power supply control unit 1280 thus restarts supplying power to the portion including the CPU 1201 in the controller 1200.

If the image forming apparatus is configured so that power is also supplied to the CPU 1201 in the sleep mode (e.g., power of a reduced amount as compared to the normal mode is supplied to the CPU 1201 in sleep 1), the power is supplied to the CPU 1201 even after the image forming apparatus shifts to the sleep mode in step S407. In such a case, the CPU 1201 may perform the determination process in step S408.

In step S409, the CPU 1201 which has restarted to receive power, performs the process for recovering the image forming apparatus 100 from the sleep mode. More specifically, the CPU 1201 executes the activation sequence using the system program backed up in the RAM 1202, and instructs the power supply unit 40 to restart supplying power to each unit in the image forming apparatus 100.

Upon receiving the instruction from the CPU 1201, the power supply unit 40 restarts supplying power to each unit in the image forming apparatus 100. As a result, the image forming apparatus 100 recovers to the normal mode.

In step S410, the CPU 1201 notifies the power consumption calculation management server 200 of the image forming apparatus recovering from the sleep mode. The content of such notification includes the mode identification information of the image forming apparatus. The power consumption calculation management server 200 which receives the notification thus becomes capable of appropriately managing the sleep time of the image forming apparatus. After ending the process of step S410, the CPU 1201 ends the process performed in the image forming apparatus.

The process to be performed in the power consumption calculation management server will be described below. In step S421, the CPU 1301 in the power consumption calculation management server 200 determines whether the information on shifting to the sleep mode has been received from the image forming apparatus. If the CPU 1301 determines that the information has not been received from the image forming apparatus (NO in step S421), the process proceeds to step S422.

In step S422, the CPU 1301 transmits the request for the power measurement value to the target image forming apparatus (i.e., the image forming apparatus which is not in the sleep state). The CPU 1301 transmits the request via the interface unit 1341 by executing the function of the power consumption information collection unit 1342 in the power consumption calculation management program 1340.

In step S423, the CPU 1301 receives the power measurement value from the image forming apparatus, and the process proceeds to step S424. In step S423, the CPU 1301 receives the model identification information along with the power measurement value as described in the process performed in the image forming apparatus in step S404.

In step S424, the CPU 1301 adds to (accumulates) the accumulated power consumption holding unit 1346 the power measurement value received in step S423. The accumulated power consumption holding unit 1346 manages the power consumption for each image forming apparatus. The CPU 1301 thus appropriately updates in step S424 the power consumption of the target image forming apparatus, based on the model identification information.

The CPU 1301 updates the power consumption by newly adding (accumulating) the power consumption information received in step S423 and the power consumption information of the image forming apparatus corresponding to the model identification information, stored in the accumulated power consumption holding unit 1346. The model identification information is included in the data received in step S423. As a result, the accumulated power consumption holding unit 1346 stores at predetermined intervals, the latest information about the total power consumption of each image forming apparatus.

The accumulated power consumption holding unit 1346 thus stores the accumulated information on the power consumption for each image forming apparatus. The accumulated power consumption holding unit 1346 also additively stores for each image forming apparatus, the power consumption information acquired in step S423 each time the information is acquired, associated with the acquired date and time. Upon ending the process of step S424, the CPU 1301 ends the process performed in the power consumption calculation management server.

On the other hand, if the CPU 1301 determines that the information on shifting to the sleep mode has been received from the image forming apparatus (YES in step S421), the process proceeds to step S425.

In step S425, the CPU 1301 performs the addition process with respect to the accumulated power consumption holding unit 1346 based on the received information on shifting to the sleep mode. More specifically, the information on the image forming apparatus shifting to the sleep mode received in step S421 includes the information on the power measurement value measured immediately before the image forming apparatus shifts to the sleep mode, and the model identification information. The CPU 1301 adds (accumulates) the information on the power measurement value to the power consumption information of the image forming apparatus corresponding to the model identification information, stored in the accumulated power consumption holding unit 1346.

The accumulated power consumption holding unit 1346 thus stores the accumulated power consumption information for each image forming apparatus. Further, the accumulated power consumption holding unit 1346 additively stores for each image forming apparatus, the power consumption information included in the information on shifting to the sleep mode received in step S421. The power consumption information is stored each time the information is received, associated with the date and time of receiving the information.

In step S425, the CPU 1301 also stores in the RAM 1302 or the HDD 1304, the time of receiving the information on shifting to the sleep mode. The time is stored for each image forming apparatus indicated by the model identification information added to the information on shifting to the sleep mode.

In step S426, the CPU 1301 determines whether the notification on recovering from the sleep mode is received from the image forming apparatus that has transmitted the information on shifting to the sleep mode received in step S421. If the CPU 1301 determines that the notification on recovering from the sleep mode has not been received from the image forming apparatus (NO in step S426), the process proceeds to step S427.

In step S427, the CPU 1301 determines whether there has been a request from the user managing and operating the server to the power consumption calculation management server 200 via the operation unit 1306. More specifically, the CPU 1301 determines whether the user has requested to display the power consumption information. If the CPU 1301 determines that there is no request to display the power consumption information (NO in step S427), the process returns to step S426, and the CPU 1301 continues to determine whether the notification on recovering from the sleep mode has been received.

On the other hand, if the CPU 1301 determines that there is a request to display the power consumption information (YES in step S427), the process proceeds to step S428. In step S428, the CPU 1301 estimates the amount of power consumed in the sleeping mode by the image forming apparatus corresponding to the information on shifting to the sleep mode received in step S421. The CPU 1301 estimates the power consumption using the elapsed time (i.e., the difference) from when the CPU 1301 received the information on shifting to the sleep mode in step S421 to the present when the CPU 301 has received the display request.

More specifically, the CPU 1301 executes the process of the sleep mode power consumption estimation unit 1344 in the power consumption calculation management program 1340. The CPU 1301 then performs the estimation operation, using the elapsed time between the sleep start to the present and the sleep mode power consumption table 1345. The estimation operation has been described in detail with reference to FIGS. 11 and 12, so that further description will be omitted.

In step S429, the CPU 1301 displays a combined power consumption to be described below on the LCD in the operation unit 1306, according to the display request received in step S427. The combined power consumption is a combined value of the power consumption when the image forming apparatus is in the sleep mode, and before the image forming apparatus shifts to the sleep mode. The power consumption when the image forming apparatus is in the sleep mode is estimated in step S428. The power consumption before the image forming apparatus shifts to the sleep mode is stored in the accumulated power consumption holding unit 1346.

By performing above-described process, the user managing and operating the power consumption calculation management server 200 can refer to the power consumption information up to the present. In such a case, it is not necessary for the image forming apparatus to be recovered from the sleep mode.

On the other hand, if the CPU 1301 determines that the notification on recovering from the sleep mode has been received from the image forming apparatus that has transmitted information on shifting to the sleep mode in step S421 (YES in step S426), the process proceeds to step S430.

In step S430, the CPU 1301 estimates the amount of the power consumed when the image forming apparatus is in the sleep mode. The CPU 1301 estimates the power consumption using the elapsed time (difference) between the time receiving the information on shifting to the sleep mode and the time receiving the notification of recovering from the sleep mode.

More specifically, the CPU 1301 executes the process of the sleep mode power consumption estimation unit 1344 in the power consumption calculation management program 1340. The CPU 1301 then performs the estimation operation, using the elapsed time between the sleep start to recovering from the sleep mode, and the sleep mode power consumption table 1345. Since the estimation has been described in detail with reference to FIGS. 11 and 12, further description will be omitted.

In step S431, the CPU 1301 adds to (accumulates) the accumulated power consumption holding unit 1346 the power consumption acquired by the power estimation operation in step S430. The accumulated power consumption holding unit 1346 manages the power consumption for each image forming apparatus, and the CPU 1301 appropriately updates the power consumption of the target image forming apparatus based on the model identification information.

The CPU 1301 updates the power consumption of the target image forming apparatus as follows. The notification of recovering from the sleep mode received in step S426 includes the model identification information. The CPU 1301 newly adds (accumulates) the power consumption information estimated in step S430 to (on) the power consumption information of the image forming apparatus stored in the accumulated power consumption holding unit 1346 corresponding to the received model identification information. As a result, the accumulated power consumption holding unit 1346 stores the accumulated value to which the estimated power consumption in the sleep mode is added, along with the power measurement value received from the image forming apparatus.

Further, the accumulated power consumption holding unit 1346 also additively stores for each image forming apparatus, the power consumption information estimated in step S430 each time the information is estimated. The estimated power consumption information is stored associated with the date and time of the image forming apparatus recovering from the sleep mode. Upon ending the process of step S431, the CPU 1301 ends the process performed in the power consumption calculation management server.

According to the above-described process, the power consumption calculation management server 200 becomes capable of appropriately managing the power consumption of the plurality of image forming apparatuses while reducing the power consumed when measuring the power consumption. Further, when the image forming apparatus is in the sleep mode, the power consumed up to the present can be calculated without recovering the image forming apparatus from the sleep mode. The calculated power consumption can then be displayed on the operation unit, so that the user can confirm the power consumption.

The above-described configurations of the various data and the contents are not limitations, and may take various configurations and contents according to usage and objective.

Further, embodiments may be realized as a system, an apparatus, a method, a program or a storage medium. More specifically, the present invention may be applied to a system including a plurality of devices, or to an apparatus including a single device. Furthermore, all combinations of the above-described exemplary embodiments are within the scope of the embodiments.

Aspects can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention. In an example, a computer-readable medium may store a program that causes an electronic device to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-200573 filed Sep. 8, 2010, which is hereby incorporated by reference herein in its entirety.

What is claimed is:

1. An electronic device configured to operate in one of a first power mode and a second power mode during which power consumption is lower than during the first power mode, the electronic device comprising:
a measurement unit configured to measure power consumption of the electronic device in the first power mode;
a first calculation unit configured to calculate power consumption of the electronic device in the second power mode; and
a second calculation unit configured to calculate total power consumption of the electronic device by adding power consumption measured by the measurement unit and power consumption calculated by the first calculation unit.

2. The electronic device according to claim 1, wherein the measurement unit does not measure the power consumption in the second power mode.

3. The electronic device according to claim 1, wherein, after the electronic device recovers from the second power mode to the first power mode, the first calculation unit calculates, in the first power mode, power consumption of the electronic device during the second power mode.

4. The electronic device according to claim 1, further comprising a storage unit configured to previously store information on power consumption per unit time in the second power mode,
wherein, using both elapsed time from when the electronic device shifts to the second power mode to when the electronic device recovers to the first power mode and information on power consumption per unit time of the electronic device in the second power mode stored in the storage unit, the first calculation unit calculates power consumption of the electronic device in the second power mode.

5. The electronic device according to claim 1, wherein the second calculation unit stores, in a holding unit, the calculated total power consumption of the electronic device, the electronic device further comprising an output unit configured to output power consumption information stored in the holding unit.

6. An electronic device management system, comprising:
at least one electronic device, where each electronic device is configured to operate in one of a first power mode and a second power mode during which power consumption is lower than during the first power mode and includes a measurement unit configured to measure power consumption of the at least one electronic device in the first power mode, and a power consumption notification unit configured to notify a management apparatus of power consumption information measured by the measurement unit as power consumption notification; and
a management apparatus connected to be communicable with each electronic device via a network to manage each electronic device, wherein the management apparatus includes a collection unit configured to collect power consumption of the at least one electronic device in the first power mode measured by the at least one electronic device, a first calculation unit configured to calculate power consumption of the at least one electronic device in the second power mode, and a second calculation unit configured to calculate total power consumption for each electronic device by adding power consumption collected by the collection unit and power consumption calculated by the first calculation unit for each electronic device.

7. The electronic device management system according to claim 6, wherein the measurement unit does not measure the power consumption in the second power mode.

8. The electronic device management system according to claim 6, wherein the at least one electronic device further includes an operation mode notification unit configured to transmit, to the management apparatus, an operation mode shift notification indicating that the at least one electronic device has shifted from the first power mode to the second power mode, or from the second power mode to the first power mode,
wherein the management apparatus further includes a power supply state management unit configured to determine whether the at least one electronic device is in the second power mode or in the first power mode according to the operation mode shift notification received from the at least one electronic device,
wherein the collection unit requests a first electronic device determined to be in the first mode by the power supply state management unit, for power consumption of the first electronic device in the first power mode measured by the first electronic device, and
wherein the power consumption notification unit notifies the management apparatus of power consumption measured by the measurement unit as power consumption notification according to a request from the management apparatus.

9. The electronic device management system according to claim 8, wherein the first calculation unit calculates power consumption in the second power mode of a second electronic device determined by the power supply state management unit to have shifted from the second power mode to the first power mode, using elapsed time from when the second electronic device has shifted to the second power mode to when the second electronic device has recovered to the first mode.

10. The electronic device management system according to claim 8, wherein the first calculation unit calculates power consumption of the first electronic device determined by the power supply state management unit to be in the second power mode, from when the first electronic device has shifted to the second power mode up to the present, using elapsed time from when the first electronic device has shifted to the second power mode up to the present.

11. The electronic device management system according to claim 9, further comprising a storage unit configured to previously store information on power consumption per unit time in the second power mode,
wherein the first calculation unit calculates, using the elapsed time and information on power consumption per unit time of the first electronic device in the second power mode stored for each electronic device in the first storage unit, power consumption of the first electronic device in the second power mode.

12. The electronic device management system according to claim 8, wherein the operation mode notification unit and the power consumption notification unit include, in the notifications, identification information of the first electronic device.

13. The electronic device management system according to claim 8, wherein, when the first electronic device shifts from the first power mode to the second power mode, the operation mode notification unit includes, in the operation mode shift notification, power consumption information measured by the measurement unit.

14. The electronic device management system according to claim 6, wherein the second calculation unit holds in a holding unit the calculated total power consumption of the at least one electronic device, the electronic device management system further comprising an output unit configured to output power consumption information for each electronic device held in the holding unit.

15. The electronic device management system according to claim 14, wherein the first calculation unit calculates power consumption of the at least one electronic device before the output unit outputs power consumption information.

16. The electronic device management system according to claim 14, wherein the at least one electronic device further includes a power consumption display unit configured to acquire, from the management apparatus, and display, on a display unit in the at least one electronic device, power consumption information of the at least one electronic device, and
wherein the output unit transmits to the at least one electronic device, power consumption information of the at least one electronic device stored in the holding unit, according to a request from the at least one electronic device.

17. A method for controlling an electronic device configured to operate in one of a first power mode and a second power mode during which power consumption is lower than during the first power mode, the method comprising:
measuring power consumption of the electronic device in the first power mode;
calculating power consumption of the electronic device in the second power mode; and
calculating total power consumption of the electronic device by adding the measured power consumption and the calculated power consumption.

18. A method for an electronic device management system having at least one electronic device and a management apparatus connected to be communicable with each electronic device via a network to manage each electronic device, where each electronic device is configured to operate in one of a first power mode and a second power mode during which power consumption is lower than during the first power mode, the method comprising:
measuring, using the at least one electronic device, power consumption of the at least one electronic device in the first power mode;
notifying, using the at least one electronic device, the management apparatus of measured power consumption information as power consumption notification;
collecting, using the management apparatus, power consumption of the at least one electronic device in the first power mode measured by the at least one electronic device;
calculating, using the management apparatus, power consumption of the at least one electronic device in the second power mode;
calculating, using the management apparatus, total power consumption for each electronic device by adding collected power consumption and calculated power consumption for each electronic device.

19. A non-transitory computer-readable storage medium storing a program causing an electronic device management system to perform a method according to claim 18.

20. A non-transitory computer-readable storage medium storing a program causing an electronic device to perform a method according to claim 17.
